(19) United States
(12) Patent Application Publication
(10) Pub. No.: US 2010/0017738 A1
(43) Pub. Date: Jan. 21, 2010

(54) PROJECT TRACKING SOFTWARE WITH COMPACT VISUAL ELEMENTS THAT INDICATE TASK COMPLETION AND OVERDUE STATUS

(76) Inventors: Gary J. Rhodes, Springfield, IL (US); Glenn H. Farrell, Peoria, IL (US)

Correspondence Address: Russ Weinzimmer, 614 Nashua Street, Suite 53, Milford, NH, 03055, US

(21) Appl. No.: 12/176,395

(22) Filed: Jul. 20, 2008

(51) Int. Cl. G06F 3/048

(52) U.S. Cl. 715/772

(57) ABSTRACT

A user interface and method of use thereof are disclosed that provide a compact and efficient overview of the status of a plurality of projects by using variable qualities of sub-task elements instead of a time-proportional timeline to indicate whether a sub-task is complete, not due, or overdue. Preferred embodiments present a grid of cells with projects in rows and sub-tasks in columns or vice-versa, and use variable qualities of cells to indicate completeness, time remaining, and/or degrees of lateness. A discrete set or a continuous range of variable qualities can indicate degrees of earliness or lateness, and can be chosen or defined by a user. Embodiments allow a user to input a deadline and/or completion status for a sub-task. In some method embodiments, the software operates on a server and the user interface is presented by a client communicating with the server over a network or the internet.

### FIELD OF THE INVENTION

The invention generally relates to the management of projects, and more specifically to computer software user interfaces that display the status of projects.

### BACKGROUND OF THE INVENTION

Modern life is getting faster and more complicated. People are expected to accomplish more and more, quicker than ever before. New product developments that used to take years now require weeks. Ad campaigns are executed, movies launched, buildings erected, websites built, all in a fraction of the time these projects formerly required. The complexity of individual projects is growing too. More functionality is required and more compatibility issues need to be addressed, frequently in light of complex, international regulatory requirements.

It is often convenient to manage a project by dividing the project into sub-tasks that must be completed so as to complete the project as a whole. For example, sub-tasks required so as to construct a building may include approval of architectural drawings, ordering of materials, digging the foundation, pouring the foundation, erecting the frame, and so forth.

Software tools are often used to track and manage the progress and status of projects. These software tools typically display graphs and/or charts that provide a visual overview of an entire project and of the status of the various sub-tasks included in the project. One common type of chart used for displaying the status of a project is a so-called Ghant chart, which provides a horizontal, time-proportional timeline and displays the relative timing of various sub-tasks of a project by indicating them as horizontal lines or bars according to the expected and/or actual start and end dates for the sub-tasks. Typically, the sub-tasks are offset vertically from one another so as to avoid overlap, and a degree of completeness is indicated on the lines or bars. Other types of graphs, charts, and checklists are used to provide overviews of projects, most of which use time-proportional timelines to provide visual representations of the on-time or overdue status of sub-tasks.

These approaches typically suffer from two limitations. First, they do not easily display the status of sub-tasks with widely varying completion times. For example, if a sub-task requiring many months to complete is followed in a Ghant chart by several sub-tasks that are vital to the project but each require only a day or two to complete, the shorter duration sub-tasks may be visibly overshadowed by the long duration sub-task, making it difficult to visually grasp the overall status of the project.

The second limitation is that these approaches are not easily adapted to simultaneously displaying multiple projects. Sometimes it is desirable to manage a family of similar, but independent projects that take place concurrently. For example, a sales manager may wish to oversee the progress of all current sales cases in his department, where each sales case typically progresses through the same basic set of steps, such as initial contact, mailing of marketing literature, site visit, submission of a bid, and final acceptance or rejection of the bid. Ghant charts and many other commonly used graphical methods for displaying the status of projects are not easily adapted to such situations. A Ghant chart, for example, relies on displaying sub-tasks in separate rows, so as to avoid graphical overlap of concurrent subtasks. If, for example, each project requires five rows in a Ghant chart, and if it is desired to track 20 such projects, then it becomes difficult or impossible using Ghant charts to display the status of all of the projects on a single page or screen.

### SUMMARY OF THE INVENTION

A user interface and method of use thereof are claimed that are able to conveniently and compactly provide an overview of the status of a plurality of projects. The user interface displays a plurality of visual sub-task elements, with each visual sub-task element corresponding to a sub-task of a project, and avoids the drawbacks inherent in approaches based on time-proportional timelines by changing a visible quality of the sub-task elements instead of using a time-proportional timeline to indicate whether each sub-task is complete, not complete and not overdue, or not complete and overdue. Preferred embodiments further indicate degrees of lateness and/or degrees of earliness.

The visual sub-task elements can be graphical elements, such as cells in a table, or they can be alphanumeric elements, such as text elements arranged in rows and columns. The changeable visible quality of the sub-task elements can be a background color, a degree of shading, a pattern of cross-hatching, a visual sub-task element size, a rate of blinking, an alphanumeric character, a choice of font, or any other quality that readily indicates a completion or overdue status. The lack of a time-proportional timeline allows the visual sub-task elements to be sized and arranged in a convenient manner that avoids overlap and presents the status of the plurality of projects in a compact and easily interpreted manner.

In preferred embodiments the visual sub-task elements are cells arranged in a table, with each row representing a project. In some of these embodiments where each of the projects includes the same set of sub-tasks, each column represents one of the sub-tasks. In similar embodiments, each column represents a project, and in some of these embodiments each row represents a sub-task. Each cell includes a changeable quality such as a background color, that can be used to indicate if the associated sub-task is completed, not yet due, modestly overdue, very overdue, not applicable, and so forth. A number or alphanumeric string can also be included in a cell to indicate how much time remains before the associated sub-task is due, or how much time has elapsed since the associated sub-task was due.

One general aspect of the invention is an article of manufacture for displaying status information regarding at least one project, each project including a plurality of sub-tasks with associated deadlines, each sub-task being overdue if it has not been completed and the associated deadline has passed. The article of manufacture includes computer-readable media containing software that is able to direct the actions of a computer so as to cause the computer to present a user interface displaying a plurality of visual sub-task elements. Each of the visual sub-task elements corresponds to a specific sub-task of a specific project, and each of the visual sub-task elements indicates at least whether the corresponding sub-task is completed, not completed and not overdue, or not completed and overdue.

In some preferred embodiments, the visual sub-task elements convey information using only alphanumeric characters, while in other preferred elements the visual sub-task elements convey information using features that are not alphanumeric.

In preferred embodiments the visual sub-task elements are cells arranged in rows and columns such that one of following cases is true:

the rows correspond to projects and the columns correspond to sub-tasks; or

the columns correspond to projects and the rows correspond to sub-tasks.

In certain preferred embodiments, at least one of the visual sub-task elements includes an alphanumeric indication of an amount of time until the deadline associated with the corresponding sub-task will be reached or an amount of time that has elapsed since the deadline associated with the corresponding sub-task was reached. In some of these embodiments the amount of time is expressed in at least one of hours, days, weeks, months, and years.

In various embodiments, the visual indication convey information using at least one of the following:

a color;

a shading;

a cross-hatching pattern;

a blinking rate;

a visual sub-task element size;

a visual sub-task orientation;

a visual sub-task configuration;

an alphanumeric indication;

a choice of font; and

a pop-up indication activated by a pointing device.

In some preferred embodiments, the visual sub-task elements convey information using at least three discrete visual indications, while in other preferred embodiments the visual sub-task elements convey information using a visual indication having a continuously variable quality. And in certain preferred embodiments the user interface further includes a visual indication selection feature that enables a user to define visual indications available for use by the visual sub-task elements.

In preferred embodiments the user interface further includes an input feature that enables a user to input at least one of a deadline associated with a sub-task and a completion status of a sub-task.

A second general aspect of the invention is a method for displaying status information regarding at least one project, each project including a plurality of sub-tasks with associated deadlines, each sub-task being overdue if it has not been completed and the associated deadline has passed, the method including operating a computer controlled by software, the software being able to present a user interface that includes a plurality of visual sub-task elements. Each of the visual sub-task elements corresponds to a specific sub-task of a specific project; and each of the visual sub-task elements indicates at least whether the corresponding sub-task is completed, not completed and not overdue, or not completed and overdue.

In some preferred embodiments, the visual sub-task elements convey information using only alphanumeric characters, while in other preferred elements the visual sub-task elements convey information using features that are not alphanumeric.

In preferred embodiments the visual sub-task elements are cells arranged in rows and columns such that one of following cases is true:

the rows correspond to projects and the columns correspond to sub-tasks; or

the columns correspond to projects and the rows correspond to sub-tasks.

In certain preferred embodiments, at least one of the visual sub-task elements includes an alphanumeric indication of an amount of time until the deadline associated with the corresponding sub-task will be reached or an amount of time that has elapsed since the deadline associated with the corresponding sub-task was reached. In some of these embodiments the amount of time is expressed in at least one of hours, days, weeks, months, and years.

In various embodiments, the visual indication convey information using at least one of the following:

a color;

a shading;

a cross-hatching pattern;

a blinking rate;

a visual sub-task element size;

a visual sub-task orientation;

a visual sub-task configuration;

an alphanumeric indication;

a choice of font; and

a pop-up indication activated by a pointing device.

In some preferred embodiments, the visual sub-task elements convey information using at least three discrete visual indications, while in other preferred embodiments the visual sub-task elements convey information using a visual indication having a continuously variable quality. And in certain preferred embodiments the user interface further includes a visual indication selection feature that enables a user to define visual indications available for use by the visual sub-task elements.

In preferred embodiments the user interface further includes an input feature that enables a user to input at least one of a deadline associated with a sub-task and a completion status of a sub-task.

In certain preferred embodiments of this general aspect, the software operates at least partly on a server computer and the user interface is displayed on a client computer that is in communication with the server computer through a network. And in some of these embodiments, the network is the internet.

### BRIEF DESCRIPTION OF THE DRAWINGS

FIG. 1A illustrates an embodiment of the invention wherein projects are indicated as rows of graphical cells in a table, with each project having a unique set of sub-tasks;

FIG. 1B illustrates an embodiment similar to the embodiment of FIG. 1A, wherein projects are indicated as rows of alphanumeric entries in a table, with each project having a unique set of sub-tasks;

FIG. 2A illustrates an embodiment of the invention wherein projects are indicated as rows in a table, with all projects having the same set of sub-tasks, such that each column represents one of the sub-tasks;

FIG. 2B presents a close-up view of a group of cells from FIG. 2A that include numerical indications of time remaining until due or time past due; and

FIG. 3 illustrates a graphical user interface that enables a user to select background colors to be used as variable qualities of sub-task elements to indicate degrees of completeness and lateness in a preferred embodiment.

### DETAILED DESCRIPTION OF PREFERRED EMBODIMENTS

The invention is a user interface that displays a plurality of visual sub-task elements to a user, each visual sub-task element corresponding to a sub-task of a project. The invention uses changes in visible qualities of the sub-task elements rather than a time-proportional timeline to visually indicate degrees of completeness and/or lateness, thereby allowing the visual sub-task elements to be configured and arranged in a convenient fashion regardless of their relative timing or durations.

Depending on the embodiment, the user interface of the present invention can be displayed on any electronic display, including the screen of a computer, such as a personal computer, or on the display of a hand-held device such as a personal digital assistant “PDA,” cell phone, or similar device. The computer or other electronic device that generates the user interface can be a local device, or it can be a server computer or other electronic device that is in communication by wired or wireless means with the electronic display, for example over the internet over the telephone network, or over some other network.

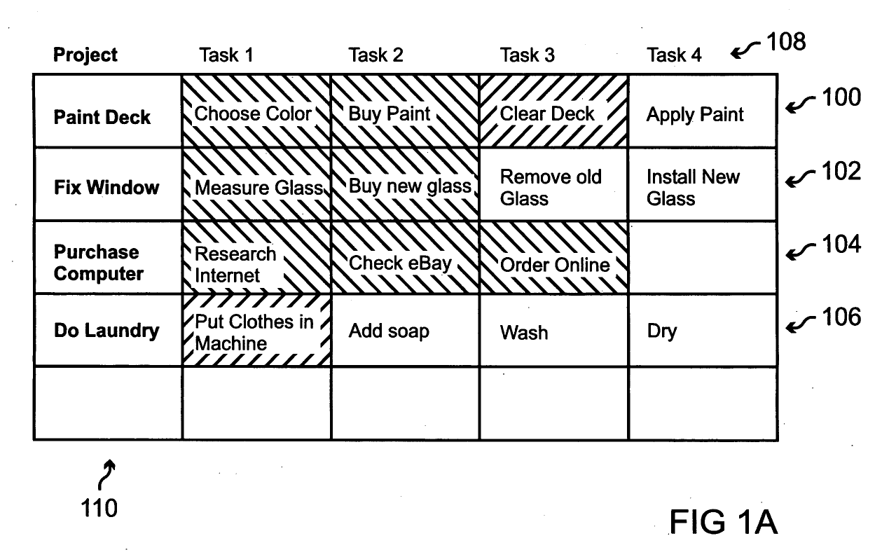

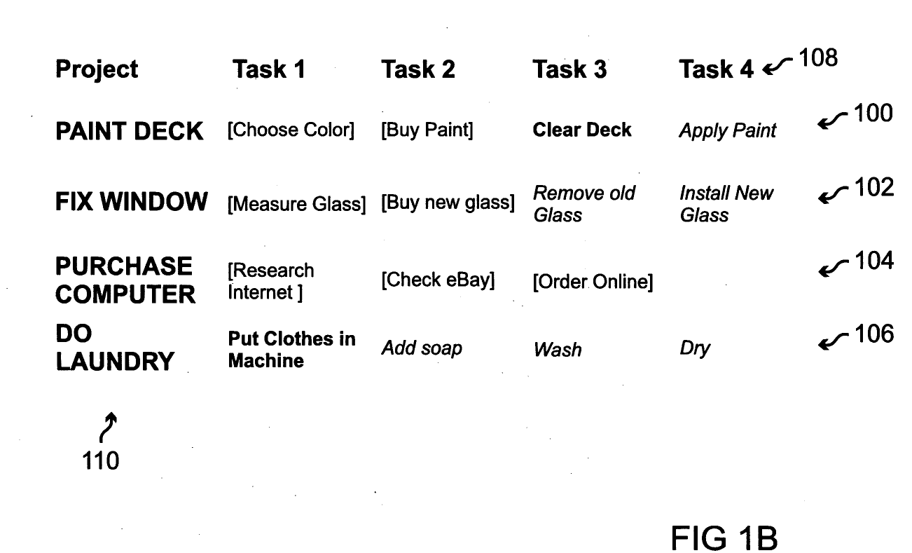

FIG. 1A illustrates a preferred embodiment in which the visual sub-task elements are graphical cells of equal size arranged in rows and columns. Each row 100, 102, 104, 106 corresponds to a project, and each cell within each row corresponds to a sub-task that must be performed so as to complete the project.

In the preferred embodiment of FIG. 1A, each project is divided into its own unique set of sub-tasks, which are generally unrelated to the sub-tasks of the other projects. Each cell includes text that indicates the nature of the sub-task, while the columns are labeled only generically as “Task 1,” Task 2,” etc 108. A column at the far left of the table 110 indicates the name of each project. Right-clicking on any cell causes display of a menu (not shown) that allows input of a due date for the corresponding sub-task and allows the status of the sub-task to be changed to “completed” or “not completed.”

Although the cells in the embodiment of FIG. 1A are of equal size, this does not imply that all of the sub-tasks require equal amounts of time to complete, nor does the fact that sub-tasks are arranged in columns imply that cells in the same column represent sub-tasks that are expected to be undertaken and/or completed concurrently. And while the arrangement of the cells within the rows might typically be according to the order in which they are expected to be completed, a user is free to arrange them in any desired order.

Cross-hatching is used in the embodiment of FIG. 1A to indicate whether a sub-task is completed, not yet completed and not yet overdue, or not yet completed and overdue. A completed sub-task is indicated by cross-hatching from upper left to lower right (see for example the “Choose Color” and “Buy Paint” sub-tasks in the “Paint Deck” project 100), while a sub-task that is not completed and is overdue is indicated by cross-hatching from upper right to lower left (see for example the “Clear Deck” sub-task of the “Paint Deck” project 100). Sub-tasks that are not completed and not yet overdue are indicated by a white background without cross-hatching (see for example the “Apply Paint” cell in the “Paint Deck” project 100).

In the specific example of FIG. 1A, four household projects are being tracked. Painting the deck 100 has been divided into four sub-tasks, Choose Color, Buy Paint, Clear Deck, and Apply Paint. It can readily be seen from the displayed user interface that the color has been chosen and the paint has been purchased, but clearing the deck is overdue, while the deadline for applying the paint has not yet arrived. The second project, fixing the window 102, has similarly been divided into four sub-tasks, and it can be seen that the first two tasks, measuring the glass and buying the glass, have been completed, while the deadlines for the second two tasks, removing the old glass and installing the new glass, have not yet arrived.

The third project in the example of FIG. 1A, Purchase Computer 104, has been divided into only three sub-tasks, all of which have been completed, and the fourth project, Do Laundry 106, has been divided into four sub-tasks, none of which have been finished, although the first sub-task is overdue.

FIG. 1B illustrates an embodiment that uses only alphanumeric visual elements to track projects. The figure uses the same set of project examples as FIG. 1A. Instead of cross-hatching, this embodiment uses alphanumeric characters and features to indicate whether a sub-task is completed, not completed and not overdue, or not completed and overdue. A sub-task name in square brackets indicates that the sub-task has been completed. See for example “Choose Color” and “Buy Paint” in the “Paint Deck” project 100. A sub-task name in bold indicates that the sub-task is not completed and overdue, and a sub-task name in italics indicates that a sub-task is not completed and not yet due. For example, in the “Paint Deck” project 100 “Clear Deck” is overdue while Apply Paint is not yet due. In similar embodiments, numbers are used as alphanumeric indications of lateness status, and some of these embodiments also include alphanumeric expressions of units such as “hours,” “days,” “weeks,” etc.

Embodiments such as the one illustrated in FIG. 1B that use only alphanumeric characters and alphanumeric properties can be optimal when the status of a project is to be presented on a display that is small, low in resolution, and/or unable to display colors. Examples include some hand-held devices, such as certain PDA's, cell phones, and hand-held computers.

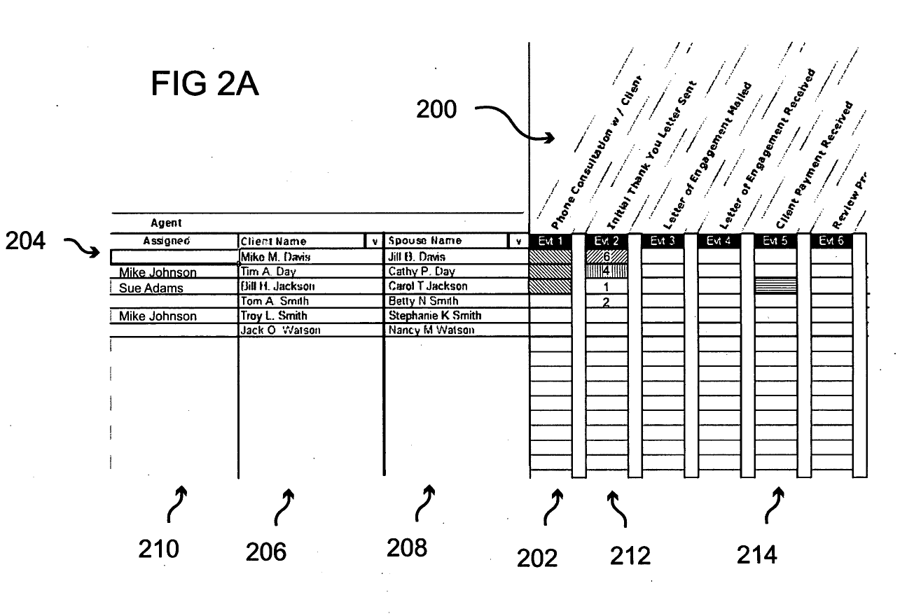

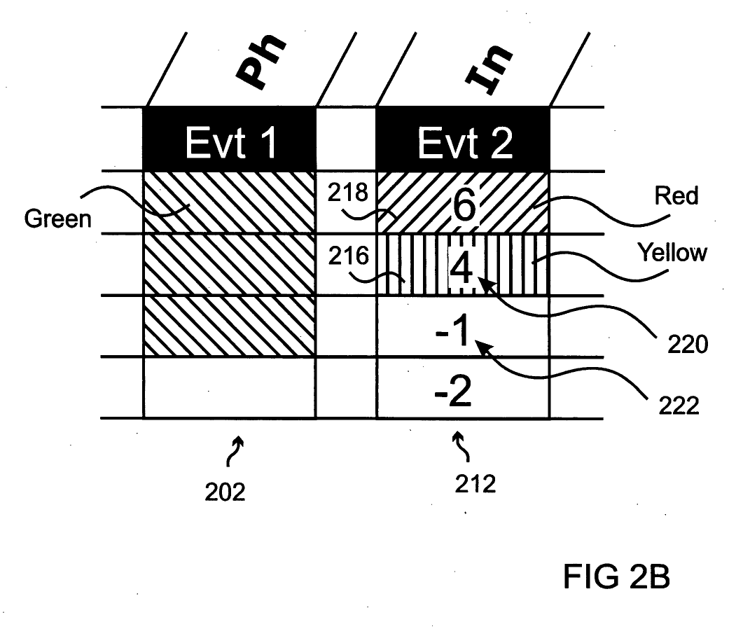

FIG. 2A presents a graphical user interface from an embodiment that tracks projects which share a common set of sub-tasks. The example illustrated in the figure is a sales process, wherein each “project” is a separate sales case. As in FIG. 1A, the sub-tasks are represented by cells of equal size arranged in rows and columns, where each row represents a project. In this embodiment, each sub-task is represented by a column, with the sub-task names 200 indicated at the tops of the columns. For example, the first column 202 contains all of the cells that correspond to the “Phone Consultation with Client” sub-tasks, with the “Phone Consultation with Client” sub-task of the first project being represented by the cell in the first column 202 of the first row 204. Information that identifies each project, or sales case in this example, is presented to the left of the sub-task columns, and includes a “client name” 206 and “spouse name” 208. An additional column 210 presents information regarding “Agents” that have been assigned to the sales cases.

FIG. 2B presents a close up view of the cells in the first 202 and second 212 columns of FIG. 2A. In this embodiment the background color of each cell indicates its completion status. Background colors are indicated in the figure with cross-hatching, with left-leaning cross-hatching indicating green, right-leaning cross-hatching indicating red, vertical cross-hatching indicating yellow, and horizontal cross-hatching indicating blue. Overdue sub-tasks are indicated by either of two background colors. If the sub-task is only modestly overdue (less than 5 days), the background color is yellow 216, while if it severely overdue (6 days or more), the background color is red 218. The degree of lateness that triggers a red background is specified in each case by the user.

It can be seen from the green background colors of the cells in the first column 202 of sub-tasks that the first sub-task has been completed for all four of the illustrated sales case projects. On the other hand, it can be seen from the background colors in the second column of sub-tasks 212 that none of the “Initial Thank-You Letter Sent” sub-tasks has been completed, and they are overdue for the first two sales cases. It can also be seen from blue background color of the fifth column (214 in FIG. 2A) that the “Client Payment Received” sub-task is not applicable to (i.e. is not a sub-task of) the third sales case.

In similar embodiments, other colors or other changeable sub-task element qualities are used to indicate sub-tasks that have been completed ahead of schedule. In other embodiments, a continuous range of colors or another variable sub-task element quality is used to visually indicate the degree to which a sub-task is overdue. For example, the background color can change continuously from yellow to orange to red as the sub-task becomes more and more overdue. In some preferred embodiments, color schemes or other changeable sub-task element qualities can be chosen and/or designed by a user. And while changeable sub-task element qualities are used uniformly for all cells in the embodiments of FIG. 1A, FIG. 1B, FIG. 2A, and FIG. 2B, some embodiments allow different changeable sub-task element qualities to be assigned to different visual sub-task elements or different groups of visual sub-task elements.

The overdue cells 216, 218 in FIG. 2B also include positive numbers 220 that indicate the amount of time that has elapsed since the corresponding sub-tasks were due, and cells that correspond to sub-tasks not yet completed include negative numbers 222 that indicate the amounts of time remaining until the sub-tasks are due. In the example of FIGS. 2A and 2B, the numbers indicate numbers of days, while in other embodiments numbers of weeks or months can be indicated. In some embodiments, units are alphanumerically indicated (e.g. days, weeks, or months) in the cells together with the numbers. For example, some embodiments would indicate “6 Days” instead of just “6” in the first cell of the second column 218.

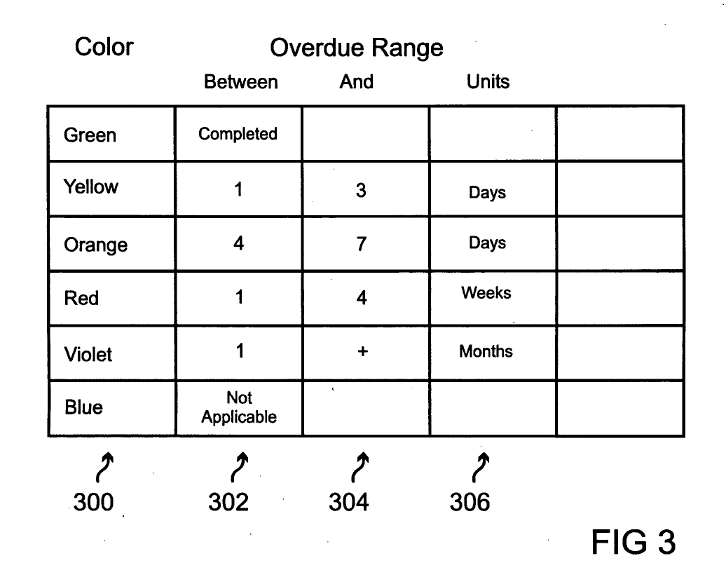

FIG. 3 illustrates a graphical user interface that enables a user to specify how colors will be used in a preferred embodiment to indicate whether a sub-task has been completed, has not completed and is not overdue, or has not been completed and is overdue. The colors to be used are indicated in the first column 300 of a table, while the completion status or degree of lateness to which each color will apply is indicated in the next two columns 302, 304. Units are indicated in the final column 306. In the example presented, a green background color indicates a completed sub-task, a yellow background color indicates a sub-task that is between 1 and 3 days late, orange indicates a sub-task that is between 4 and 7 days late, red indicates a sub-task that is between 1 and 4 weeks late, and violet indicates a sub-task that is more than a month late. Blue is used to indicate that a sub-task does not apply to a project. In other preferred embodiments similar user interfaces apply methods well known in the art to enable a user to specify a continuous range of colors or other changeable sub-task element qualities that can indicate completion and overdue status.

Other modifications and implementations will occur to those skilled in the art without departing from the spirit and the scope of the invention as claimed. Accordingly, the above description is not intended to limit the invention except as indicated in the following claims.

1. An article of manufacture for displaying status information regarding at least one project, each project including a plurality of sub-tasks with associated deadlines, each sub-task being overdue if it has not been completed and the associated deadline has passed, the article of manufacture comprising:
computer-readable media containing software that is able to direct the actions of a computer so as to cause the computer to present a user interface displaying a plurality of visual sub-task elements,
each of the visual sub-task elements corresponding to a specific sub-task of a specific project; and
each of the visual sub-task elements indicating at least whether the corresponding sub-task is one of:
completed;
not completed and not overdue; and
not completed and overdue.

2. The article of manufacture of claim 1, wherein the visual sub-task elements convey information using only alphanumeric characters.

3. The article of manufacture of claim 1, wherein the visual sub-task elements convey information using features that are not alphanumeric.

4. The article of manufacture of claim 1, wherein the visual sub-task elements are cells arranged in rows and columns such that one of following cases is true:
the rows correspond to projects and the columns correspond to sub-tasks; and
the columns correspond to projects and the rows correspond to sub-tasks.

5. The article of manufacture of claim 1, wherein at least one of the visual sub-task elements includes an alphanumeric indication of one of:
an amount of time until the deadline associated with the corresponding sub-task will be reached; and
an amount of time that has elapsed since the deadline associated with the corresponding sub-task was reached.

6. The article of manufacture of claim 5, wherein the amount of time is expressed in at least one of: hours; days; weeks; months; and years.

7. The article of manufacture of claim 1, wherein the visual sub-task elements convey information using at least one of:
a color;
a shading;
a cross-hatching pattern;
a blinking rate;
a visual sub-task element size;
a visual sub-task orientation;
a visual sub-task configuration;
an alphanumeric indication;
a choice of font; and
a pop-up indication activated by a pointing device.

8. The article of manufacture of claim 1, wherein the visual sub-task elements convey information using at least three discrete visual indications.

9. The article of manufacture of claim 1, wherein the visual sub-task elements convey information using a visual indication having a continuously variable quality.

10. The article of manufacture of claim 1, wherein the user interface further includes a visual indication selection feature that enables a user to define visual indications available for use by the visual sub-task elements.

11. The article of manufacture of claim 1, wherein the user interface further includes an input feature that enables a user to input at least one of a deadline associated with a sub-task and a completion status of a sub-task.

12. A method for displaying status information regarding at least one project, each project including a plurality of sub-tasks with associated deadlines, each sub-task being overdue if it has not been completed and the associated deadline has passed, the method comprising:
operating a computer controlled by software, the software being able to present a user interface which includes a plurality of visual sub-task elements, each of the visual sub-task elements corresponding to a specific sub-task of a specific project; and
each of the visual sub-task elements indicating at least whether the corresponding sub-task is one of:
completed;
not completed and not overdue; and
not completed and overdue.

13. The method of claim 12, wherein the visual sub-task elements convey information using only alphanumeric characters.

14. The method of claim 12, wherein the visual sub-task elements convey information using features that are not alphanumeric.

15. The method of claim 12, wherein the visual sub-task elements are cells arranged in rows and columns such that one of following cases is true:
the rows correspond to projects and the columns correspond to sub-tasks; and
the columns correspond to projects and the rows correspond to sub-tasks.

16. The method of claim 12, wherein at least one of the visual sub-task elements includes an alphanumeric indication of one of:
an amount of time until the deadline associated with the corresponding sub-task will be reached; and
an amount of time that has elapsed since the deadline associated with the corresponding sub-task was reached.

17. The method of claim 16, wherein the amount of time is expressed in at least one of: hours; days; weeks; months; and years.

18. The method of claim 12, wherein the visual sub-task elements convey information using at least one of:
a color;
a shading;
a cross-hatching pattern;
a blinking rate;
a visual sub-task element size;
a visual sub-task orientation;
a visual sub-task configuration;
an alphanumeric indication;
a choice of font; and
a pop-up indication activated by a pointing device.

19. The method of claim 12, wherein the visual sub-task elements convey information using at least three discrete visual indications.

20. The method of claim 12, wherein the visual sub-task elements convey information using a visual indication having a continuously variable quality.

21. The method of claim 12, wherein the user interface further includes a visual indication selection feature that enables a user to define visual indications available for use by the visual sub-task elements.

22. The method of claim 12, wherein the user interface further includes an input feature that enables a user to input at least one of a deadline associated with a sub-task and a completion status of a sub-task.

23. The method of claim 12, wherein the software operates at least partly on a server computer and the user interface is displayed on a client computer that is in communication with the server computer through a network.

24. The method of claim 23, wherein the network is the internet.
